(19) United States
(12) Patent Application Publication
(10) Pub. No.: US 2020/0386371 A1
(43) Pub. Date: Dec. 10, 2020

(54) BASIC FRAMEWORK FOR CONSTRUCTING LED ILLUMINATION DEVICES USING STANDARD COMPONENTS

(71) Applicant: HUNAN YUEGANG MOOKRAY INDUSTRIAL CO., LTD., Changde (CN)

(72) Inventor: Heng ZHU, Changde (CN)

(73) Assignee: HUNAN YUEGANG MOOKRAY INDUSTRIAL CO., LTD., Changde (CN)

(21) Appl. No.: 16/760,683

(22) PCT Filed: Jan. 12, 2018
(86) PCT No.: PCT/CN2018/072470

§ 371 Date: Apr. 30, 2020

(30) Foreign Application Priority Data
Aug. 4, 2017 (CN) 201710659110.2

(51) Int. Cl. F21S 2/00; F21V 29/80; F21V 23/00; F21V 19/04; F21V 23/02; F21V 23/06

(52) U.S. Cl. CPC F21S 2/005; F21V 29/80; F21V 23/003; F21Y 2115/10; F21V 23/02; F21V 23/06; F21V 19/04

(57) ABSTRACT

A basic framework for constructing an LED illumination device using standard components is provided. The standard components includes light emitting modules, a power supply connecting module, and a supporting system. Each of the light emitting module includes an LED light source integrated with a chip and a heat sink, a color temperature adjusting module, and an optical lens. The power supply connecting module includes a plurality of power supply modules with different voltage output sockets, light source bases on which the light emitting modules are assembled, power supply connectors electrically connecting the light source bases and the power supply modules and circuit connectors electrically connecting two adjacent light source bases. The supporting system includes a plurality of connecting blocks of building block-type connecting structures and rib parts.

### CROSS REFERENCE TO THE RELATED APPLICATIONS

This application is the national phase entry of International Application No. PCT/CN2018/072470, filed on Jan. 12, 2018, which is based upon and claims priority to Chinese Patent Application No. 201710659110.2, filed on Aug. 4, 2017, the entire contents of which are incorporated herein by reference.

### TECHNICAL FIELD

The present invention relates to a light emitting device using a light source of light emitting diode (LED), and more particularly to an LED illumination device of various shapes, structures and uses, the LED illumination device is assembled by the most basic and standard components including light emitting modules, a power supply connecting module and a supporting system in a manner like the building block assembly connection method.

### BACKGROUND

The LED light source, since inception, has evolved into a number of illumination products, most of which are manufactured according to the industry standards of traditional illumination products. For example, LED illumination products are manufactured basically in one-to-one correspondence according to the relevant performance parameters of traditional illumination products, such as shape, size, output power, light source color temperature and electrical properties. Therefore, LED illumination products are multiform.

At present, traditional illumination products can be roughly classified into 39 models, including indoor lamps and outdoor lamps, as follows.

Indoor lights: downlights, light bulbs, candle lights, fluorescent tube, grille lights, corn lights, panel lights, ceiling lights, recessed lights, counter lights, suctorial light, chandeliers, wall lights, floor lamps, table lamps, kitchen and bathroom lights, mirror lights, emergency lights, bathroom heat lights, shadowless lights, searchlights or spotlights, headlamp, footlights.

Outdoor lights: street lights, solar street lights, courtyard lights, buried lights, wall washing lights, tunnel lights, landscape lights, lawn lights, underwater lights, fountain lights, guardrail pipes, stage lights, movable lights, traffic lights, car lights, light strips/belts.

Based on the above designed models, thousands of different design and manufacturing solutions are derived from each model of the semiconductor light. As a result, homogeneous products have a uniform shape and function, but consists of quite different components, and accordingly, LED illumination products have a complex and diversiform structure for lack of a unified standard.

Taking 3 W, 5 W, 7 W and 9 W LED light bulbs of several models with related performance parameters as examples, the LED light bulbs are uniformly set under the following conditions, wherein the power supply is a built-in power supply, the input alternating current (AC) voltage is 100-240V with 50/60 Hz, the output current is 295±5 mA, the power factor is more than 0.40, the fitting body is made of plastic-coated aluminum, the LED chip is the 2835 LED chip with power of 0.2 W, and the luminous color is cold white/warm white. The LED light bulbs are respectively set under the following conditions.

3 W LED light bulb: output direct current (DC) voltage: 9-13 V, total power including load power: 3 W±15%, conversion efficiency: >0.75, light source power: 2.8 W, LED number: 15, and LED arrangement: 3 series 5 parallel (i.e. 5 parallel paths, each path having 3 LEDs in series).

5 W LED light bulb: output DC voltage: 15-18 V, total power including load power: 5 W±15%, conversion efficiency: >0.78, light source power: 4.5 W, LED number: 25, and LED arrangement: 5 series 5 parallel.

7 W LED light bulb: output DC voltage: 15-24 V, total power including load power: 7 W±15%, conversion efficiency: >0.80, light source power: 6 W, LED number: 30, and LED arrangement: 6 series 5 parallel.

9 W LED light bulb: output DC voltage: 24-28 V, total power including load power: 9 W±15%, conversion efficiency: >0.80, light source power: 6 W, LED number: 40, and LED arrangement: 8 series 5 parallel.

According to the above traditional illumination products, the 3 W LED light bulb is regarded as a model, but from the above comparison, the four products shown above are different in terms of housing shape, size, PCB, LED chip, power supply, color temperature and so on, which means that manufacturing the four LED light bulbs is required to design and develop 4×6=24 sets of corresponding molds. The other 38 kinds of products are similar to the light bulb mentioned above.

At present, there are about 15,000 companies in the LED illumination industry in China, more than one million employees, and more than hundreds of millions of kinds of various molds. Tens of millions of models of products are manufactured, and fall into 39 kinds of traditional lights.

According to the statistics from relevant departments in China, 1 yuan of output value can be generated only after investing a total of 2.54 yuan in the industry. In the past three years, the overall net profit margin of 24 listed companies in the domestic illumination industry has been less than 4%. MLS Co., Ltd. the largest packaging company in China, has an annual output of nearly 500 billion LED chips, accounting for nearly a quarter of the global industry, with an output value of less than 0.5% of the industry, which in fact has become an enterprise selling metal and plastic materials.

After searching for about 1.16 million pictures of light bulbs by a web search engine, 70% of them are different and accordingly require countless different molds. It can be imagined that the manufacturing efficiency is low in the industry. Once a certain model not readily marketable, resources (such as manpower, product materials and equipment investment, etc.) will be greatly wasted.

In 2016, China was the world's largest light producer, and the output value of the semiconductor illumination industry in China was 530 billion yuan with an increase of 23% year-over-year, accounting for 21% of the global market share. But in the last 20 years after the birth of the industry, there was no formal industry standard.

The root cause of the above situation is that the heat dissipation problem of LED chips has not been effectively solved in the industry over the past 20 years.

Usually, the LED chip is a gas-closed laminated structure, which will lead to poor heat conduction of the chip and directly affect the light emission and product lifetime.

LED illumination products imitate traditional illumination products, which have many thermal resistance layers. In general, when the heat transfers from the chip to the PCB and to the radiator, there are eight thermal resistance layers that the heat must pass through (total thermal resistance=chip+silver adhesive+bracket+tin paste+circuit board+insulation layer+aluminum substrate+thermally conductive fin+radiator+air. The PCB board alone has three thermal resistance layers, and the heat is blocked after flowing through the PCB board, which is sure to increase the temperature, as if the Yangtze River is suddenly blocked by the Three Gorges Dam to cause the water level increase. When the heat dissipation is hindered, the luminous efficiency and the service life of the LED chip are reduced. The thermal conductivity K (unit: W/mK) of each thermal resistance layer mentioned above is as follows.

Silver adhesive: 18; bracket: 80; tin paste: 60; copper-clad layer (circuit board): 400; insulation layer: 2; aluminum substrate: 210; thermally conductive silica gel gasket: 5; aluminum radiator: 210.

From the analysis of the above situation, on the one hand, the market is continuously being broadened, and on the other hand, the original production is still inefficient and wasteful. The increase in the resource consumption of the industry itself is more than offset by the resource savings brought by energy-efficient light bulbs. The waste of resources is shockingly enormous.

Going back to the source, in the technological development process over the past 20 years, the industry started with a wrong way, and when positioning themselves in the traditional lighting form, the subverters are subverted, thereby causing major problems such as difficulty in chip heat dissipation and standardization, homogeneous competition, and low efficiency in the industrial chain.

### SUMMARY

In order to solve the technical problem, the present invention provides a basic framework for constructing an LED illumination device using standard components, so that the LED illumination device has different shapes, structures, types and functions and is randomly assembled by the standard components including light emitting modules, a power supply connecting module, and a supporting system.

In the present invention, the technical solution for solving the above technical problem is as follows.

According to the present invention, a basic framework for constructing an LED illumination device using standard components, includes a light emitting module, a power supply connecting module, and a supporting system configured to support and decorate the LED illumination device, wherein:

at least one light emitting module is provided, and each light emitting module includes an LED light source integrated with a chip and a heat sink, a color temperature adjusting module and a light lens; wherein each of the color temperature adjusting module and the light lens is fixed on the LED light source by a quick detachable structure;

at least one power supply connecting module is provided, and each power supply connecting module includes a power supply module with a plurality of different voltage output sockets, a light source base, a power supply connector electrically connecting the light source base and the power supply module, and a circuit connector electrically connecting two adjacent light source bases; wherein, the at least one light emitting module is assembled on the light source base, and a conduction circuit is built into the light source base, and each power supply connecting module is provided with at least one light source base;

the supporting system includes a plurality of connecting blocks with a building block-type connecting structure, and a rib component; the rib component includes a connecting plate, a rib, a bar, a rod and a surrounding rail, and the rib is configured to combine all connecting blocks into brackets with different dimensions, different shapes and different sizes by a building block assembly connection method; the connecting block and the light source base are provided with a quick insertion-connected connector, the quick insertion-connected connector has a rigid structure and the quick insertion-connected connector is configured to quickly assemble the connecting block and the light source base; and

each of the LED light source, the color temperature adjusting module, the light lens, the power supply module, the light source base, the power supply connector, the circuit connector, the connecting block and the rib component is the standard component.

A base socket and a plurality of wire sockets adaptively connected to the circuit connector are arranged on the light source base; the conduction circuit in the light source base is connected between the wire socket and the base socket; three electrode terminals are arranged in each wire socket, and the three electrode terminals are a positive terminal, a midline terminal and a negative terminal, respectively; the positive terminals of all wire sockets are connected to each other by a positive wire, and the negative terminals of all wire sockets are connected to each other by a negative wire; the midline terminal of each wire socket is connected to a positive electrode or a negative electrode of the base socket through a wire.

The LED light source includes an LED chip and the heat sink for supporting the LED chip; a spatial shape surrounded by an outline of the heat sink is a truncated pyramid, a circular truncated cone, a prism or a cylinder; the heat sink is a heat conductor, or the heat sink is a support component and an outer surface of the support component is coated with a thermally conductive film; the LED chip is arranged on the top surface of the heat sink in a way of face-to-face contact; a positive lead and a negative lead of the LED chip are insulated from the heat sink and extend out to form a standard plug-in, and the standard plug-in is inserted on the base socket.

The circuit connector includes an insulated outer layer with bendable performance, a rigid joint fixed at both ends of the circuit connector, and a power supply wire built in the insulated outer layer; the power supply wire includes three wires, the three wires are the positive wire, a transition wire and the negative wire, respectively, and the three wires are successively arranged side by side; each end of two ends of each power supply wire is correspondingly fixed on the electrode terminal on the rigid joint; the positive wire is short-circuited with the transition wire to form an input power supply line of the light source base; the negative wire is short-circuited with the transition wire to form an output circuit line of the light source base; the positive wire, the transition wire and the negative wire in the circuit connector are arranged in parallel to form an electric energy transmission line, and a plurality of light emitting modules are connected in series by the electric energy transmission line.

The rigid joint is connected to the wire socket on the light source base by a male-female fit connection structure, and the positive wire, the transition wire and the negative wire are electrically connected to the positive terminal, the midline terminal and the negative terminal, respectively.

Three LED chips connected in series are arranged between the positive electrode and the negative electrode of the base socket.

The connecting block is a cube, a cuboid, a sphere, a truncated pyramid or a circular truncated cone, and the connecting block is provided with a plurality of quick insertion-connected sockets arranged in different planes and at least one elastic snap-fit head; the quick insertion-connected connector is arranged between the quick insertion-connected sockets of the two adjacent connecting blocks.

The rib component includes a long strip-like metal plate having a certain strength to play a supporting role, and the long strip-like metal plate is bendable and twistable; a plurality of snap-fit holes are arranged at intervals from one end to the other end of the long strip-like metal plate; snap-fit edges at two sides of the long strip-like metal plate are provided with concave-convex structures at intervals; the concave-convex structure of the snap-fit edge at one side of the long strip-like metal plate and the concave-convex structure of the snap-fit edge at the other side of the long strip-like metal plate are alternate relative to each other in a direction of the long edge side of the long strip-like metal plate; the connecting block is fixed on a plate surface of the long strip-like metal plate by inserting the elastic snap-fit head into the snap-fit hole.

The rib component further includes a plate connector with at least two elastic snap-fit heads, and the elastic snap-fit head can be inserted into one of the snap-fit holes on different long strip-like metal plates respectively to fix together the long strip-like metal plates, wherein the number of the long strip-like metal plates corresponds to the number of the elastic snap-fit heads.

Two elastic snap-fit heads are provided on the plate connector, and the two elastic snap-fit heads are arranged on the same side, on adjacent sides, or on opposite sides.

A distance between the two elastic snap-fit heads arranged on the same side of the plate connector is greater than a distance between two adjacent snap-fit holes on two long strip-like metal plates when the two long strip-like metal plates are laterally connected; alternatively, the distance between the two elastic snap-fit heads arranged on the same side is equal to the distance between two adjacent snap-fit holes on the two long strip-like metal plates when the two long strip-like metal plates are longitudinally connected.

The plurality of elastic snap-fit heads are provided on the plate connector, and the plurality of elastic snap-fit heads are arranged on the same side; all elastic snap-fit heads are fixed on a side of the cuboid; when two long strip-like metal plates are laterally coupled, a distance between two adjacent elastic snap-fit heads is not less than a distance between two adjacent snap-fit holes on the two long strip-like metal plates.

The rib component further includes at least one rod connector or pipe connector, and the connecting block is correspondingly provided with a spiral hole, a snap-fit hole or a through hole, wherein the rod connector or the pipe connector can be fixed to the spiral hole, the snap-fit hole or the through hole.

A surface of the connecting block provided with the quick insertion-connected socket is provided with a cover, and the cover is configured to cover the quick insertion-connected socket; a surface shape of the cover is the same as a surface shape of the connecting block provided with the quick insertion-connected socket.

A housing of the power supply module is provided with a plurality of power output sockets, at least one utility-frequency power connection socket and at least one elastic snap-fit head, and DC output voltages of the power output sockets range from 12V to 48V.

The power supply module is further provided with a digital signal transmission line and an IC chip configured to control different light emitting modules.

The power supply module is further provided with at least one wire socket, and the circuit connector connect at least two power supply modules for use.

The power supply connector includes an insulated outer layer with bendable performance, a rigid joint fixed at both ends of the power supply connector, and a power supply wire built in the insulated outer layer; the power supply wire includes three wires, the three wires are a positive wire, a transition wire and a negative wire, respectively, and the three wires are successively arranged side by side; each end of two ends of each power supply wire is correspondingly fixed on an electrode terminal on the rigid joint; when the positive wire is short-circuited with the transition wire to form an input power supply line of the light source base, the light source base is connected to the power supply module by the input power supply line; when the negative wire is short-circuited with the transition wire to form an output circuit line of the light source base, the light source base is connected to the power supply connector by the output circuit line; when the positive wire, the transition wire and the negative wire in the power supply connector are arranged in parallel to form a parallel connection line, a plurality of light emitting modules are connected in series by the parallel connection line.

The LED illumination device is an illumination light or a large indicator light, including a table lamp, a wall lamp, a hanging light, a chandelier, a suctorial ceiling light, a globular light, a decorative light, a street light, a tunnel light, a car light and others; alternatively, the LED illumination device is a phototherapy instrument for light physiotherapy.

A light transmission cover is arranged on the LED illumination device.

The present invention takes W/CM³ as a unit to establish a standard product system, and uses a limited standard module to construct a limitless variable LED light-emitting device. The LED light-emitting device can be an independent light-emitting product or a plurality of combinations of multiple products, thereby realizing module standardization, core light source modularization, power supply modularization, circuit connection modularization, and decorative illumination and lens modularization of the product. The present invention takes the well-known W/CM³ light source module as the basic standard platform and extends it appropriately. In this way, four types of module product standards are established, so product standards for specific types of lights are no longer set.

From the perspective of people's habits, the light source module in units of watts and cubic centimeters is easily comprehensible and convenient to use, handle, install and maintain.

From the perspective of industry product standards, the four types of module standards are directed to the key issues in the prior art, and are concise and explicit, with variable forms and unchanging essence. Furthermore, the present invention not only develops the chip technology of upstream industry, and formulates industry standards for core modules, but also promotes the diversification of downstream applications and the development of differentiated markets.

The present invention can completely solve the heat dissipation problem of the chip. According to the aforementioned thermal resistance analysis, the heat conduction of the chip integrated with the light source has only one layer of thermal resistance. The heat dissipation effect of the chip of the present invention can be obtained from the test data of five CEPREI Laboratories in Guangzhou, Ministry of Industry and Information Technology of China (test report number: T1605WT8888-01245).

The product of the present invention is tested by an infrared thermal imager after lighting for 4 hours at room temperature (25° C.±2° C.). The temperature of the core of the light source and the highest temperature of the housing of the radiator are 65° C. and 63.4° C., respectively, indicating that the heat dissipation efficiency of the chip is greatly improved. And according to Guangdong Innovation Center (full name: Guangdong Semiconductor Lighting Industry Joint Innovation Center, hereinafter referred to as: Innovation Center), under the same conditions, the standards for the temperature of the core of the light source and the highest temperature of the housing of the radiator are set as 125° C. and 75° C., respectively.

The light emitting device constructed by the present invention has a much smaller volume and weight than that of the prior art, which is simpler, more convenient and cheaper than the prior art.

Taking the geometric dimensions and weight of the street light and the downlight as an example, the comparison between the present and the prior art is as follows.

The LED street light of the present invention: length: 37 cm, width: 28 cm, height: 4.7 cm, weight: 2713 g.

The LED street light of the prior art: length: 60 cm, width: 33 cm, height: 7 cm, weight: 7727 g.

The downlight of the present invention: inner diameter: 11.5 cm, outer diameter: 14.5 cm, height: 2 cm, weight: 197 g.

The downlight of the prior art: inner diameter: 10 cm, outer diameter: 13.5 cm, height: 9 cm, weight: 752 g.

The relevant heat dissipation parameters (average volume and weight of the aluminum radiator per watt, allowable maximum temperature of the chip, and allowable maximum temperature of the housing) of the products from the PHILIPS Company and the MLS Co., Ltd. (stock code 002745) are compared with that of the present invention as follows:

PHILIPS Company: volume (cm³/W) of the aluminum radiator: 19; weight (g/W) of the aluminum radiator: 30.7; allowable maximum temperature (° C.) of the chip: no corresponding parameter; allowable maximum temperature (° C.) of the housing: no corresponding parameter.

MLS Co., Ltd.: volume (cm³/W) of the aluminum radiator: 17.66; weight (g/W) of the aluminum radiator: 28.6; allowable maximum temperature (° C.) of the chip: no corresponding parameter; allowable maximum temperature (° C.) of the housing: no corresponding parameter.

Standards set by Innovation Center: volume (cm³/W) of the aluminum radiator: 12.25; weight (g/W) of the aluminum radiator: 19.85; allowable maximum temperature (° C.) of the chip: 125; allowable maximum temperature (° C.) of the housing: 75.

Product of the present invention: volume (cm³/W) of the aluminum radiator: 2.1; weight (g/W) of the aluminum radiator: 3.4; allowable maximum temperature (° C.) of the chip: 65; allowable maximum temperature (° C.) of the housing: 63.4.

Based on the above data, compared with the prior art, the heat conduction efficiency of the LED illumination device manufactured by the basic framework of the present invention is increased by 4 times to 6 times than that of the prior art, thereby completely solving the heat dissipation problem of the chip in prior art, reducing the volume and weight of the product in the prior art by more than 70% and reducing the cost by more than 60%. The present invention meets the diversity of product applications, such as free shape, flexible size, free amount of light, optional light color. The product is installed in pluggable manner, and can be easily maintained, which achieves a sustainable upgrading in the service cycle.

At the same time, the present invention greatly simplifies the product standards, and in future, illumination products are only manufactured by typical functional modules rather than stereotyped end products. The module standard is finite, which is easy for supervising and managing the industry. The product can be combined infinitely, so that everyone can design the desired product by themselves.

The present invention comprehensively and thoroughly realizes the technical idea of “simpler, more convenient and cheaper”.

### BRIEF DESCRIPTION OF THE DRAWINGS

FIGS. 1-10 are schematic diagrams of an LED illumination device constructed by the basic framework of the present invention.

FIG. 11 is an exploded view of the LED illumination device in FIG. 10.

FIGS. 12-1 to 12-3 are schematic diagrams showing the light emitting module of the present invention in different angles.

FIG. 12-4 is an exploded view of the light emitting module in FIG. 12-1.

FIG. 13-1 is a schematic diagram showing a light emitting module including a plurality of LED chips.

FIG. 13-2 is an enlarged view showing the LED module portion in the central area of FIG. 13-1.

FIG. 14 is a schematic diagram showing another structure of a light emitting module of the present invention.

FIG. 15 is a schematic diagram showing yet another structure of a light emitting module of the present invention.

FIG. 16 is a schematic diagram showing a structure of a heat sink on the light emitting module of the present invention.

FIG. 17 is a schematic diagram showing another structure of the heat sink on the light emitting module of the present invention.

FIG. 18 is a schematic diagram showing yet another structure of the heat sink on the light emitting module of the present invention.

FIGS. 19-22 are schematic diagrams showing the connection structures of the light emitting module and each of different light source bases according to the present invention.

FIG. 23 is a schematic diagram showing two-dimensional or three-dimensional connectors with various shapes and structures.

FIG. 24 is a schematic diagram showing the shapes of multiple kinds of power supply connectors or circuit connectors.

FIG. 25 is a schematic diagram showing the application of the circuit connector of FIG. 24.

FIG. 26 is a first schematic diagrams of the circuit connection between the circuit connector and the light source base (three-series three-parallel circuit, that is, three sets of LED modules are connected in parallel, each set of LED modules includes three LED chips connected in series).

FIG. 27 is a second schematic diagram of the circuit connection between the circuit connector and the light source base (three-way three-series circuit, that is, three light source bases are connected in series, and each light source base is equipped with one LED chip).

FIG. 28 is a schematic diagram showing the shape of the power supply module of the present invention.

FIG. 29 is a schematic diagram showing that a plurality of power supply modules are connected to the power supply connectors.

FIG. 30 is a schematic diagram showing the bending application of the long strip-like metal plate and the bending application of connecting more than two long strip-like metal plates in the rib components of the present invention.

FIG. 31 is a schematic diagram of a plurality of plate connectors for connecting the long strip-like metal plates in the rib components of the present invention.

FIG. 32 is a schematic diagram showing two connecting blocks.

FIG. 33 is a schematic diagram showing the outer surface of a cover that can cover the surface of the connecting block.

FIG. 34 is a schematic diagram showing the quick insertion-connected connector 312 that can connect two connecting blocks together.

FIG. 35 is a schematic diagram showing the application of each plate connector in FIG. 31.

In the figures:

light emitting module 1, LED light source 11, LED chip 111, light-gathering cavity 112, wire groove 113, positioning member 114, wire 115, annular flange 116, through hole 117, LED module 118, electrode lead 119, heat sink 12, heat dissipation structure 13, regular polyhedron 14, color temperature adjusting module 15, fluorescent lens 151, plastic lens 1511, annular frame 1512, light lens 16, power supply connecting module 2, power supply module 21, power supply connector 211, light source base 22, two-dimensional base 221, three-dimensional base 222, base socket 223, wire socket 224, positive terminal 2241, midline terminal 2242, negative terminal 2243, two-dimensional or three-dimensional connector 225, circuit connector 23, insulated outer layer 231, rigid joint 232, power supply wire 233, positive wire 2331, transition wire 2332, negative wire 2333, supporting system 3, connecting block 31, cover 311, quick insertion-connected connector 312, rib component 32, long strip-like metal plate 321, snap-fit hole 3211, connecting edge 3212, plate connector 322, elastic snap-fit head 4, cuboid bracket 41, quick insertion-connected socket 5, male plug-in 6, internal thread 71, external thread 72, light transmitting cover 8, LED illumination device 9.

### DETAILED DESCRIPTION OF THE EMBODIMENTS

In the present invention, a basic framework for constructing LED illumination devices using standard components is as follows: based on the W/CM³ light source module that people are accustomed to use as the basic standard platform, and the standard light emitting module 1, the power supply connecting module 2, and the plurality of kinds of supporting system 3 composed of standard components are adopted to construct the LED illumination devices 9 with different functions, uses and shapes.

The LED illumination device 9 constructed by using the basic framework of the present invention can be uniformly specified by the national standardization department and then popularized in the industry, which greatly contributes to the industry even the nation.

The LED illumination devices 9 may include light emitting and heating devices such as a fixed illumination device, a mobile illumination device, a heating device and a physiotherapy device, which use LED light emitting chips for light emitting and heating.

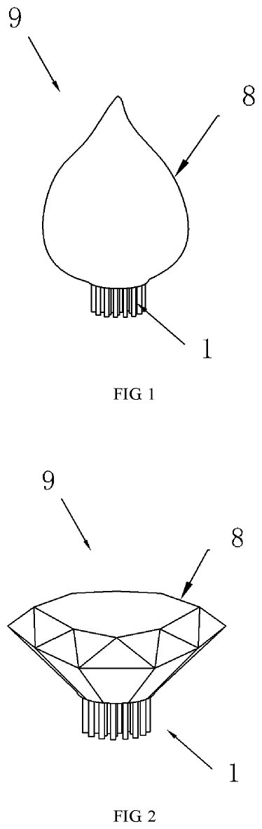

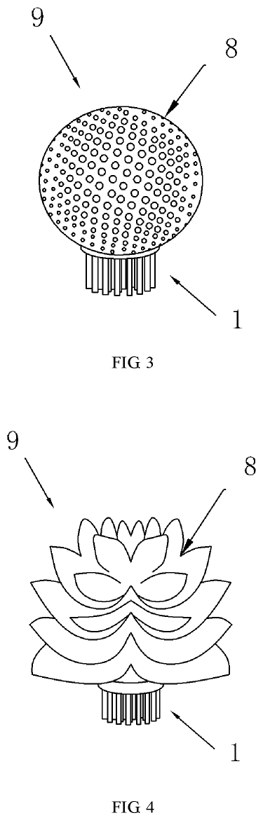

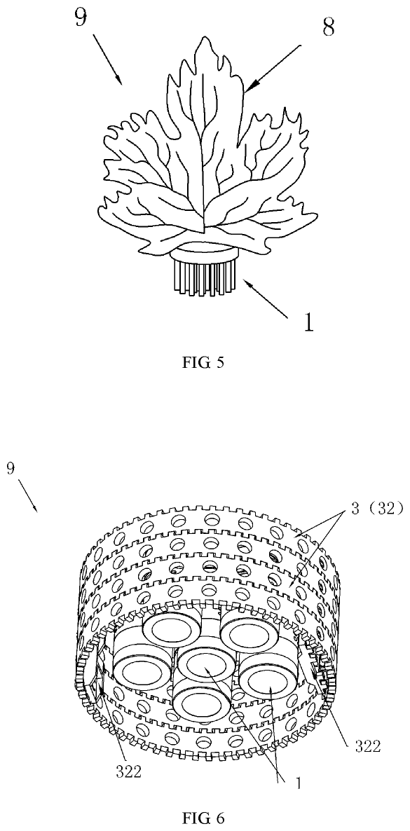

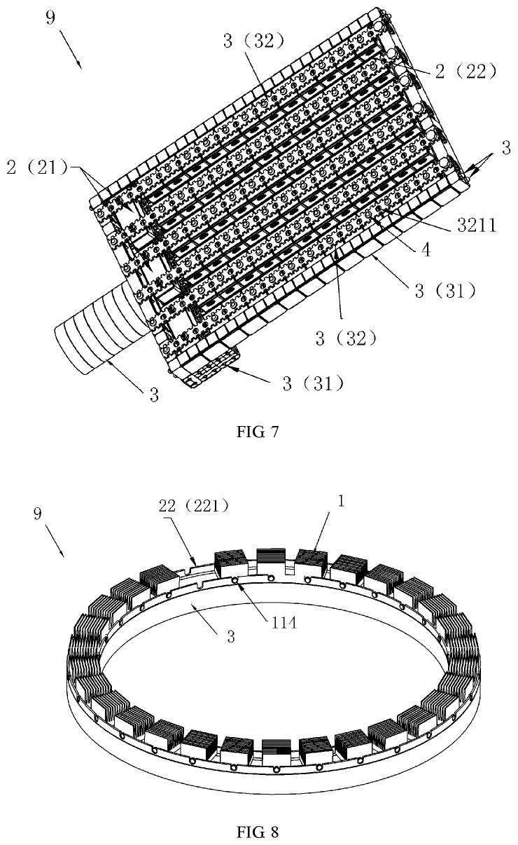

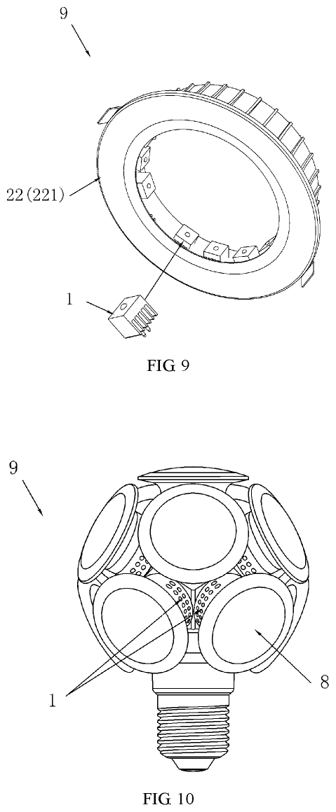

As shown in FIGS. 1-11, the illumination device includes 39 types of traditional illumination products, and further includes a variety of illumination lights or large indicator lights that are not limited to a table lamp, a wall lamp, a hanging light, a chandelier, a suctorial ceiling light, a globular light, a decorative light, a street light, a tunnel light and a car light, which can meet customized needs and have different shapes.

The heating device includes, but is not limited to, a household heater, a bathroom heat light, a warm light for recreation, an outdoor heater, and a dual-function lamp for beautifying the surrounding, as well as heating and lighting.

The physiotherapy device includes an extracorporeal phototherapy instrument and an intracorporal sterilization instrument, such as a diathermy instrument, a dehumidification instrument, a cell growth instrument for accelerating wound repair and a built-in sterilization instrument for gynecology.

The shapes of the light emitting surfaces of the phototherapy instrument and the sterilization instrument can be designed to be matched with the shape of the body to be treated or the shape of the part to be treated according to the ergonomic principle.

Light Emitting Module 1.

The light emitting module 1 is the smallest standard light emitting component that can constitute the LED illumination device 9. The LED illumination device 9 can be provided with a plurality of light emitting modules 1.

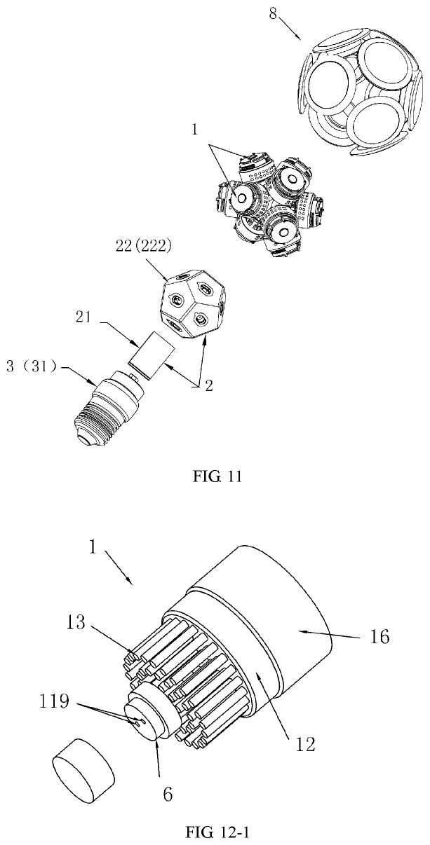

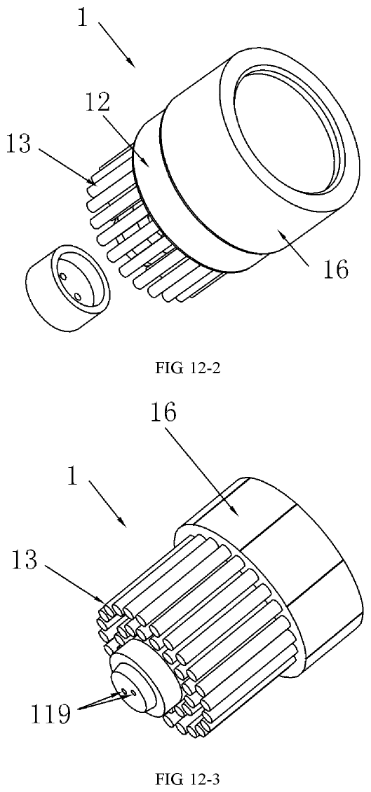

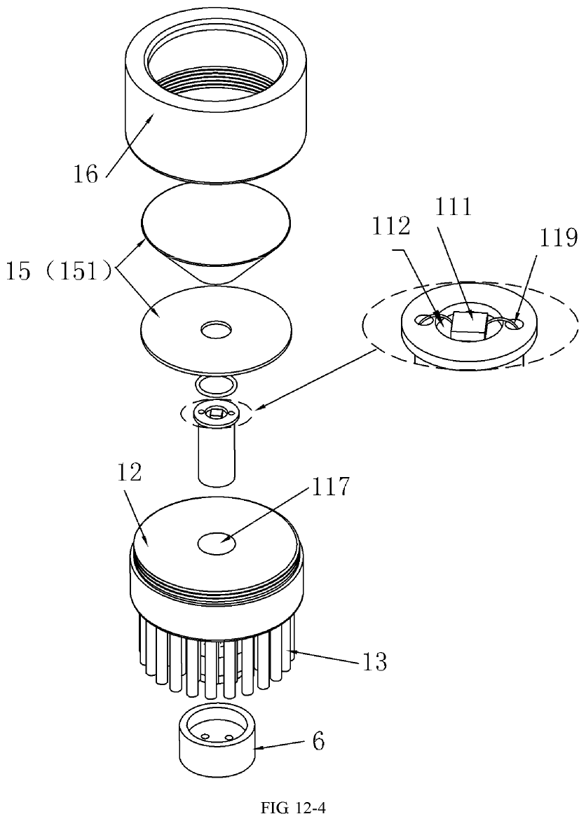

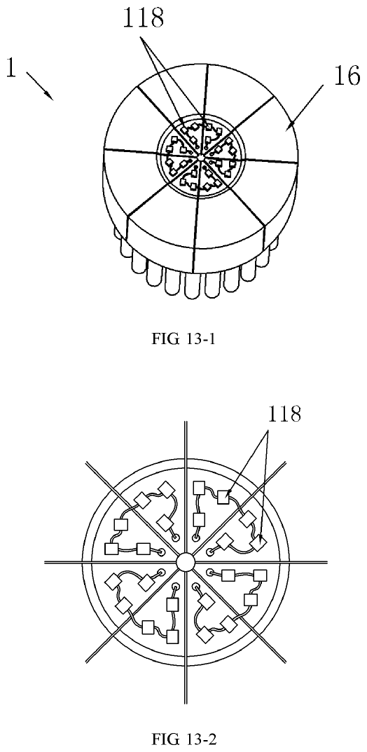

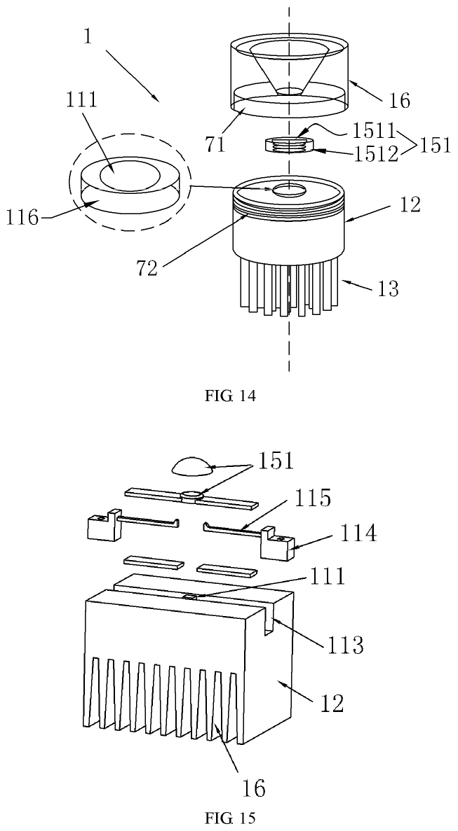

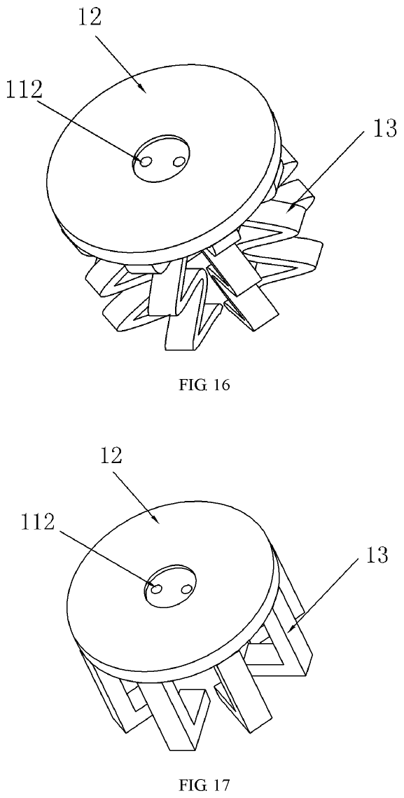

As shown in FIGS. 12-1 to 12-4, 14 and 15, each light emitting module 1 includes the LED light source 11 integrated with a chip and a heat sink, the color temperature adjusting module 15 and the light lens 16, wherein each of the color temperature adjusting module 15 and the light lens 16 is fixed on the LED light source 11 by a quick detachable structure.

(I) LED light source 11.

The LED light source 11 includes the LED chip 111 and the heat sink 12 for supporting the LED chip 111. The body surface area of the heat sink 12 is much larger than that of the LED chip 111, and the body surface area of the heat sink 12 is mostly exposed to the atmosphere.

1. LED chip 111

The LED chip 111 can be a chip using the common package technique or the flipchip package technique. Different from the prior art, the LED chip 111 of the present invention is not provided with a chip bracket and a heat dissipation copper pillar.

2. Heat sink 12.

The heat sink 12 is made of material with good thermal conductivity, such as pure metal material. Alternatively, a thermally conductive film made of thermally conductive material can be arranged on the surface of a cylinder made of hard plastic with thermal conductivity as the heat sink 12 (this structure can reduce the cost of the material).

The spatial shape surrounded by the outline of the heat sink 12 is a truncated pyramid, a circular truncated cone, a prism or a cylinder, that is, the shape of the heat sink 12 may be a cylinder, a cuboid, a cube, an elliptical cylinder (in other words, the cross section of the heat sink 12 is circular, rectangular, square or oval), the regular polyhedron 14, or a hollow plate body that bends the edge of rectangular plate or circular plate downward to form a truncated pyramid shape, circular truncated cone, a prismatic shape or a cylindrical shape.

The positive lead and the negative lead of the LED chip 111 are insulated from the heat sink 12 and extend out to form a standard plug-in, and the standard plug-in is inserted on the light source base 22 in the power supply connecting module 2.

Preferably, the heat sink 12 of the present invention is a copper column or an aluminum column, and the maximum outer diameter of the heat sink 12 is 25 mm.

3. Integrated structure of the chip and the heat sink 12

One or more LED chips 111 are arranged in face-to-face contact with the top surface of the heat sink 12, and the installation modes are as follows.

(1) a mode: when only one LED chip is provided, the shape of the heat sink 12 is a cylinder, a cuboid, a cube, an elliptical cylinder or the hollow plate body.

The light-gathering cavity 112 for embedding the LED chip 111 is arranged at the center of the top surface of the heat sink 12, the light-gathering cavity 112 is recessed into the top surface of the heat sink 12, and the LED chip 111 is fixed in the light-gathering cavity 112 by the silver adhesive.

When the LED chip 111 is a chip with a formal structure, the substrate of the LED chip 111 includes sapphire, silicon or silicon carbide, and the bottom surface of the substrate and the inner bottom surface of the light-gathering cavity 112 are fixedly connected by the silver adhesive. When the LED chip 111 is a chip with a flip structure, the substrate of the LED chip 111 includes silicon or ceramic, and the bottom surface of the substrate and the inner bottom surface of the light-gathering cavity 112 are fixedly connected by the silver adhesive. Since the heat sink 12 is provided with a thermally conductive film with a large body surface area or the heat sink 12 is a large heat conductor, the LED chip 111 and the heat sink 12 are in close face-to-face contact with each other, so that the heat generated by the working chip is quickly absorbed by the heat sink 12 and quickly discharged to the external space.

The electrical connection structure in the a mode is as follows: the wire groove 113 is arranged on both side of the light-gathering cavity 112 on the top surface of the heat sink 12. The positioning member 114 extending outward is arranged at the outer end of the wire groove 113 and fixed on the heat sink 12. The wire 115 is placed in the wire groove 113 and is insulated from the heat sink 12. The inner end of the wire 115 is connected to an electrode corresponding to the LED chip 111, and the other end of the wire 115 is connected to the electrical contact of the positioning member 114.

In order to further improve the heat dissipation effect of the heat sink 12, the heat dissipation structure 13 capable of quickly discharging heat away is arranged on the bottom surface of the heat sink 12. The heat dissipation structure 13 includes a plurality of vertical fins extending downward and arranged at intervals from each other, or the heat dissipation structure 13 includes a plurality of vertical rods extending downward and arranged at intervals from each other, or the heat dissipation structure 13 is a bending plate extending downward formed by bending a flat plate multiple times.

The heat dissipation structure 13 formed by the vertical fins, the vertical rods and the bending plate is made of metal with good thermal conductivity, which can be integrated with the heat sink 12, or can be tightly fastened to the heat sink 12 through the fastener.

(2) b mode: the b mode has the same structures as the aforementioned a mode except for the electrical connection structure thereof.

In the b mode, the through hole 117 penetrating the heat sink 12 along the axis of the heat sink 12 is arranged at the center of the top surface of the heat sink 12. The LED chip 111 is fixed on the top surface of the heat sink 12 in the method described in the aforementioned a mode. The electrode leads 119 (i.e. the positive lead and the negative lead of the LED chip 111) respectively corresponding to the positive electrode and the negative electrode of the LED chip 111 extend downward and are inserted in the insulating sleeves. The electrode leads 119 together with the insulating sleeves are inserted into the through hole 117. The lower ends of the electrode leads 119 are exposed under the bottom surface of the heat sink 12 or the heat dissipation structure 13 and are inserted in the male plug-in 6. The male plug-in 6 can be matched with and adaptively inserted into the female plug-in (i.e. the base socket 223) on the light source base 22. As a result, the LED chip 111 and the peripheral components are connected electrically.

In the b mode, the heat generated by the LED chip 111 can be also quickly discharged out, which is the same as the aforementioned a mode.

(3) c mode: the c mode has the same structure as the above a and b two modes except for the number and the arrangement of LED chips 111 thereof.

In the c mode, a plurality of regions insulated from each other are arranged on the top surface of the heat sink 12, and the LED modules 118 composed of a plurality of LED chips 111 are arranged in parallel or in series on each region. The LED modules 118 on the top surface of the entire heat sink 12 may be connected to each other in a parallel way, a serial way, or a serial-parallel way. The positive and negative electrical connection circuit may adopt the electrical connection structure described in the a mode or b mode.

In the c mode, the heat generated by the LED chip 111 can be also quickly discharged out, which is the same as the aforementioned a and b two modes.

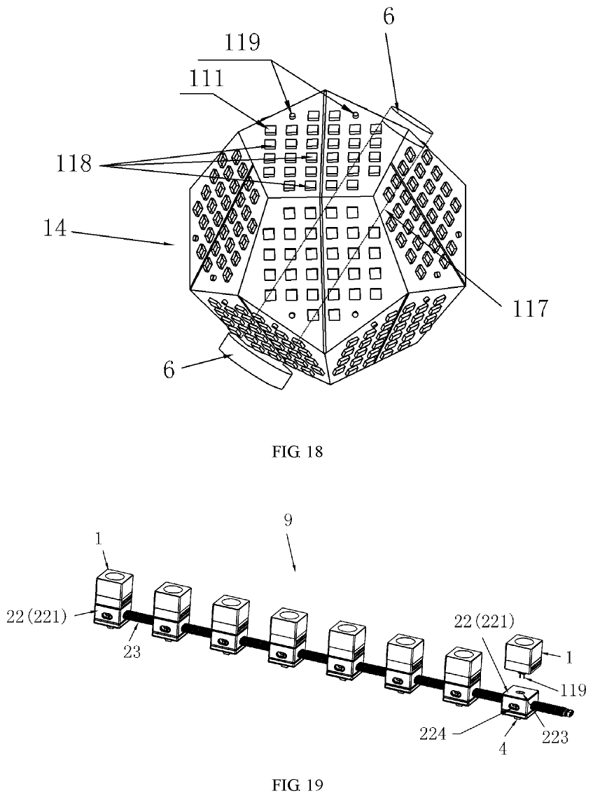

(4) d mode: the d mode has the same structure as the above c mode except that the shape of the heat sink 12 thereof (see FIG. 18).

In the d mode, the shape of the heat sink 12 is the regular polyhedron 14, and a plurality of LED chips are arranged on a plurality of surfaces in a manner same as the c mode, thereby achieving the purpose of emitting light to the peripheral three-dimensional space.

In the d mode, the electrode wires of each LED module 118 can extend in the manner of the electrical connection structure of the aforementioned a mode, b mode, or the combination of a mode, and b mode.

In the d mode, the heat generated by the LED chip 111 can be also quickly discharged out, which is the same as the aforementioned a, b and c three modes.

(II) color temperature adjusting module 15

The color temperature adjusting module 15 includes the fluorescent lens 151 integrated with the plastic lens 1511 and the annular frame 1512, wherein the plastic lens 1511 is doped with the fluorescent powder according to the required color temperature (which can be obtained by uniformly mixing the plastic lens 1511 with the fluorescent powder of the required color temperature through a single or double injection molding process), and the annular frame 1512 is made of metal or opaque plastic material. The plastic lens 1511 is fixed to the center of the annular frame 1512. The annular frame 1512 is mounted on the annular flange 116 arranged around the LED chip 111 by a quick detachable structure (such as a screw, a snap buckle, or a male-female clamping connection structure).

When the user needs to replace the color adjusting module due to different color temperature requirements, it is only necessary to remove the unsuitable fluorescent lens 151 and place the new fluorescent lens 151 according to the required color temperature, which is very convenient.

(III) Light lens 16

The light lens 16 is a standard component, the shape and the emission angle of the light lens 16 are set to a variety of different models. The model of the present invention is preferably cylindrical, and the light lens 16 is on an end surface of the cylinder.

The external thread 72 is arranged on the outer peripheral wall of the heat sink 12, and correspondingly, the internal thread 71 engaged with the external thread 72 is arranged on the inner circumferential wall of the cylinder of the light lens 16. Alternatively, a clamping member extending upwardly is arranged on the periphery of the top surface of the heat sink 12, and correspondingly, a fastener member matched with the clamping member is arranged on the inner circumferential wall of the cylinder of the light lens 16.

This structure is convenient for users to replace the light lenses 16 with different shapes or light emission angles at any time according to their favorite requirements for different light emission angles.

Power Supply Connecting Module 2

The power supply connecting module 2 includes the power supply module 21, the light source base 22 and the circuit connector 23, which are all standard components. The LED illumination device 9 may be provided with a plurality of groups of the power supply connecting modules 2.

(I) Power supply module 21

1. The socket and output of the power supply module 21

The power supply module 21 is configured to provide electric energy to the LED illumination device 9, and the power supply module 21 is provided with a voltage input socket and a plurality of DC voltage output sockets (hereinafter referred to as wire socket 224). The voltage input socket can be a socket directly connected to the utility-frequency power, a socket connected to other power supply device, or a USB charging socket. The output voltages of the plurality of DC voltage output sockets are different, and the present invention preferably adopts the DC output voltage of 12V-48V.

The power supply module 21 is further provided with the digital signal transmission line and the IC chip that controls different light emitting modules 1, so as to control the corresponding LED light sources 11 to turn on or turn off according to a set frequency.

The wire sockets 224 on the power supply module 21 can connect at least two power supply modules 21 through the power supply connector 211 for use, or connect the power supply module 21 to the load (i.e. the light emitting module 1) through the power supply connector 211.

2. The housing of the power supply module 21

The shape of the housing of the power supply module 21 is designed according to the overall shape and the spatial redundancy of the LED illumination device 9, including a cuboid, a cuboid with half-cylindrical ends at both ends, a broken ring body with a circular arc section, or a body formed by a combination of a multi-curved surface and a plurality of planes with different inclination angles.

The housing of the power supply module 21 is further provided with a plurality of elastic snap-fit heads 4 (see FIG. 28). The elastic snap-fit head 4 is configured to mount the power supply module 21 on the corresponding light source base 22 or mount the power supply module 21 on the connecting block 31 in the supporting system 3.

3. Power supply connector 211

The DC voltage output socket of the power supply module 21 supplies power to the corresponding light source base 22 through the power supply connector 211.

The power supply connector 211 has different models of lengths, generally ranging from 12 mm to 100 mm. When the power supply connector 211 is relatively short, the power supply connector is a rigid structure; and when the power supply connector 211 is relatively long, the power supply connector includes the insulated outer layer 231 with bendable performance and the rigid joint 232 fixed at both ends of the power supply connector 211. The power supply wire 233 is arranged in the rigid structure or the insulated outer layer 231 of the power supply connector 211.

The settings of the power supply wire 233 are as follows:

(1) The power supply wire 233 includes two long wires and one short wire.

Two electrode contacts are arranged on the rigid joint 232 at one end of the power supply connection member 211 connected to the power supply module 21, and the two electrode contacts are a positive terminal and a negative terminal, respectively. Three electrode contacts are arranged on the rigid joint 232 at the other end of the power supply connection member 211 connected to the light source base 22, and the three electrode contacts are a positive terminal, a negative terminal, and a terminal of the transition wire 2332, respectively. The two long wires are the positive wire 2331 and the negative wire 2333. The positive wire 2331 is connected between the positive terminals at both ends of the power supply connector 211. Similarly, the negative wire 2331 is connected between the negative terminals at both ends of the power supply connector 211. The one short wire is the transition wire 2332 arranged at the end of the light source base 22. The inner end of the transition wire 2332 is short-circuited with the positive wire 2331 or the negative wire 2333, and the outer end of the transition wire 2332 is connected to the terminal of the transition wire 2332.

When the power supply connector 211 is connected to the light source base 22 through a quick insertion-connected head structure, the three electrode contacts (the positive terminal, the negative terminal and the terminal of the transition wire 2332) on the power supply connector 211 are electrically connected to the positive terminal 2241, the negative terminal 2243 and the midline terminal 2242 on the wire socket 224 arranged on the light source base 22, respectively.

(2) The power supply wire 233 includes three long wires.

Three electrode contacts are respectively arranged on the rigid joints 232 at both ends of the power supply connection member 211, which are the positive terminal, the negative terminal, and the terminal of the transition wire 2332, respectively. The three long wires are the positive wire 2331, the transition wire 2332 and the negative wire 2333, which are successively arranged side by side. Each end of the two ends of each power supply wire 233 is correspondingly fixed on the electrode terminal on the rigid joint 232.

Specifically, a point on the transition wire 2332 near the light source base 22 terminal is short-circuited with the positive wire 2331 or the negative wire 2333.

4. Use of power supply connector 211.

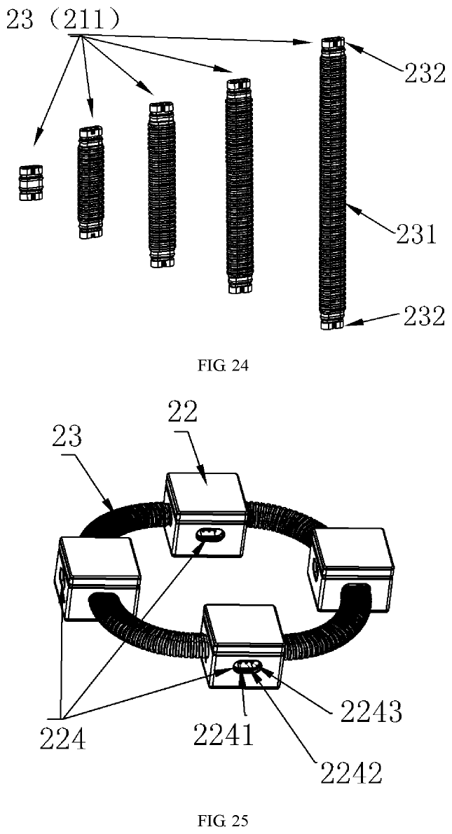

As shown in FIGS. 24, 26 and 27, when the positive wire 2331 is short-circuited with the transition wire 2332, the power supply connector 211 is the input power line for the power supply module 21 to supply power to the light source base 22, that is, the positive output circuit of the power supply module 21. When the negative wire 2333 is short-circuited with the transition wire 2332, the power supply connector 211 is the output circuit wire of the light source base 22 connected to the power supply module 21, that is, the negative output circuit of the power supply module 21.

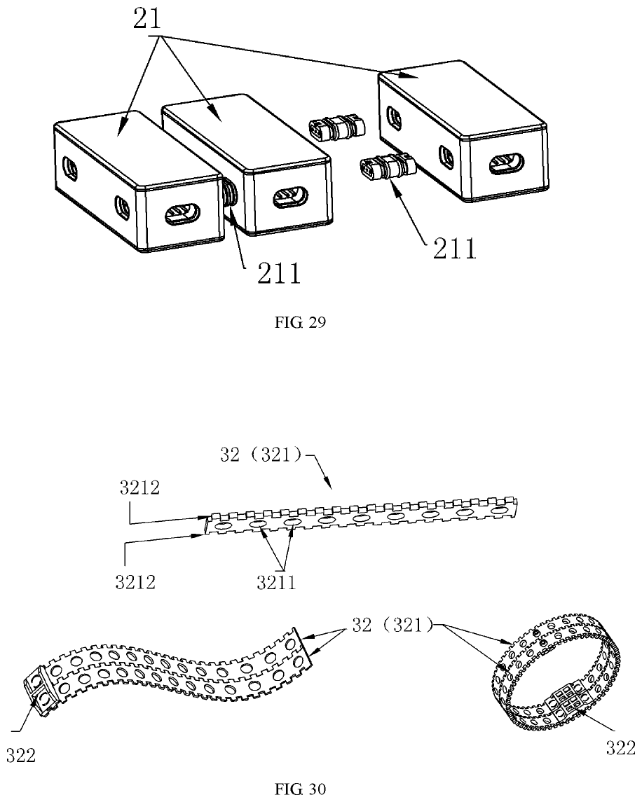

When the positive wire 2331, the transition wire 2332 and the negative wire 2333 in the power supply connector 211 are arranged in parallel without being short-circuited with each other, the power supply connector 211 forms a connection line by which a plurality of power supply modules 21 are connected in series to use (see FIG. 29).

(II) Light source base 22

1. The function, classification and basic framework of the light source base 22.

The light source base 22 is configured to install the light emitting module 1 in a pluggable manner.

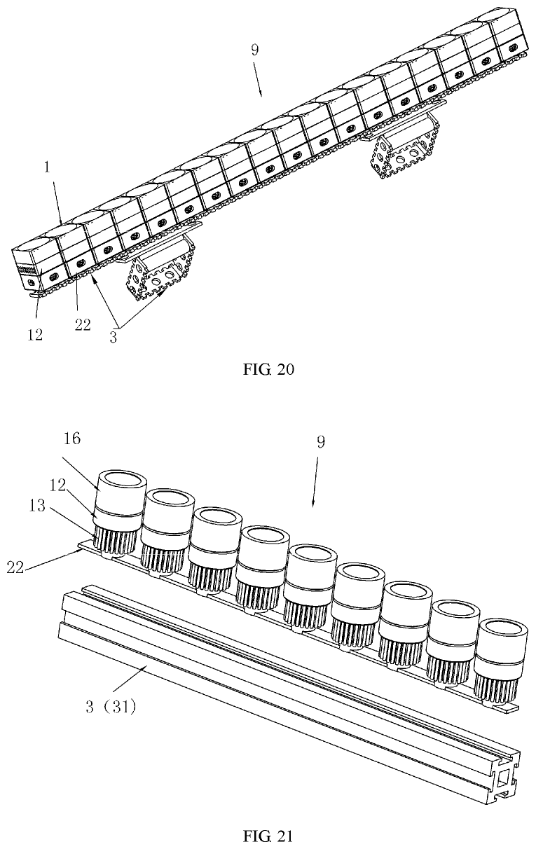

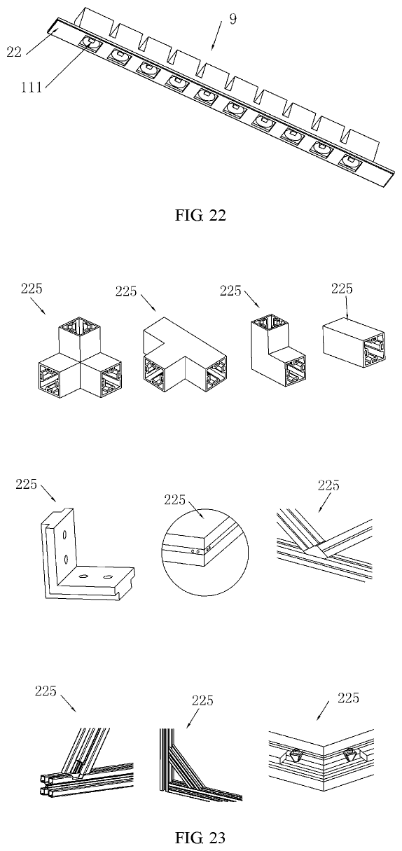

The light source base 22 may be a base for assembling one light emitting module 1, or a base for simultaneously installing a plurality of the light emitting modules 1. Specifically, the light source base 22 may be a two-dimensional base 221 and a three-dimensional base 222 (see FIGS. 11, 19-22).

The numerically equal light emitting modules 1 can be installed on each light source base 22 in a quick detachable connection mode and a quick insertion-connected electrical connection mode. The quick detachable connection structure can be separated from or integrated with the quick insertion-connected electrical connection structure.

For example, the elastic snap-fit head 4 is arranged on the light source base 22, and the elastic snap-fit head 4 is configured to quickly mount the light source base 22 on the corresponding connecting block 31 in the supporting system 3. Alternatively, the snap-fit holder (i.e. the quick insertion-connected socket) is arranged on the light source base 22 and is quickly connected to the elastic snap-fit head 4 on the power supply module 21.

The light source base 22 is made of hard plastic or soft silica gel, or the light source base 22 can also include a metal housing with an insulated inner core sleeve.

A conductive path is arranged in the light source base 22, and the conductive path is an embedded conductor for electrical connection arranged by a single or double injection molding process. The embedded conductor is copper foil or the wire 115, which is embedded in the light source base 22. Alternatively, the embedded conductor is the RV wire with large cross-sectional area and low resistance value, which is embedded in the surface layer of the light source base 22 and the wire groove 113 of the wire 115 having an opening.

The quick detachable structure includes, but is not limited to, a snap-fit connection structure, a male-female fit connection structure, a screwed connection structure or a lock pin-based hinge connection structure.

The quick insertion-connected electrical connection structure includes, but is not limited to, an electrically conductive connector with elasticity, a connector connection structure or a male-female fit plug-in connection structure.

2. Two-dimensional base 221

The shape of the two-dimensional base 221 includes, but is not limited to, straight shape, cross shape, arc shape, closed or open circular ring shape, elliptical ring shape, rectangular frame shape, hollow or solid square disk shape, hollow or solid disk shape, or hollow or solid ellipse disk shape.

Specifically, the difference between the ring shape and the hollow disk shape is that the numbers of the light emitting module 1 arranged along the radial direction are different. Only one light emitting module 1 is arranged along the radial direction of the ring shape, while the plurality of light emitting modules 1 can be arranged side by side along the radial direction of the hollow disk shape. Similarly, the difference between the rectangular frame shape and the hollow square disk shape, and the difference between the elliptical ring shape and the hollow elliptical disk shape only are that the numbers of light emitting modules 1 arranged side by side along the radial direction are different.

The plurality of light emitting modules 1 can be arranged side by side along the short side direction of the straight shape, the cross shape and the arc shape. The light source base 22 of the straight shape, the cross shape and the arc shape may be a rigid structure or an elastic bendable structure.

Using different combinations, the two-dimensional base 221 for supporting the light emitting module 1 can be assembled into the independently working two-dimensional light source device (that means that the two-dimensional light source device can be sold and used as an independent light emitter).

The two-dimensional light source device can be assembled by the following combination.

(1) The light emitting module 1 is adaptively installed on the corresponding two-dimensional base 221 to form the two-dimensional light source device, which is point-source light.

(2) The plurality of light emitting modules 1 are adaptively installed on the corresponding two-dimensional base 221 to form the two-dimensional light-emitting device, which can emit line-source light, multi-line cross light, or area-source light. Specifically, the light emitting modules 1 can be electrically connected in series, in parallel or in a way of series-parallel connection.

(3) The plurality of two-dimensional bases 221 (wherein, each two-dimensional base 221 carries a plurality of light emitting modules 1) are combined into the two-dimensional light source device arranged in the two-dimensional space by the two-dimensional or three-dimensional connector 225 with a quick detachable connection structure (see FIG. 23), which can emit multi-line cross light, or continuous or intermittent area-source light. Specifically, the two-dimensional bases 221 can be electrically connected in series, in parallel or in a way of series-parallel connection.

(4) Definition of the two-dimensional base 221

The two-dimensional base 221 is not defined entirely according to the shape. In the present invention, the light source base 22 capable of meeting one of the following requirements is defined as the two-dimensional base 221:

a. When all LED chips 111 in the two-dimensional light source device are in the same plane, the light source base 22 constituting the two-dimensional light source device can be determined to be the two-dimensional base 221.

b. Judging from the shape of the light source base 22, when the shapes, projected in the XY plane, of the outlines of the combination formed by all light source bases 22 constituting the two-dimensional light source device are basically the same in the Z-axis direction, the light source bases 22 constituting the two-dimensional light source device can be determined to be the two-dimensional bases 221.

3. Three-dimensional base 222

The shape of the three-dimensional base 222 is diversified, which is basically determined by the fact that the LED chips 111 of the plurality of light emitting modules 1 on the three-dimensional base 222 are in different three-dimensional coordinate positions; or, the outline of the light source base 22 includes a plurality of curved surfaces with different curvature; or the light source base 22 is a complex shape composed of a combination of a plurality of planes having different tilt angles from the ground plane.

Like the three-dimensional base 222 mentioned above, the three-dimensional base 222 can also constitute the independently working three-dimensional light source device arranged in the three-dimensional space as follows.

(1) The light emitting module 1 is adaptively installed on the corresponding three-dimensional base 222 to form the three-dimensional light source device, which can emit point-source light.

(2) The plurality of light emitting modules 1 are adaptively installed on the corresponding three-dimensional base 222 to form the three-dimensional light source device, which can emit point-source light, line-source light or area-source light in multi-direction in the three-dimensional space. Specifically, the light emitting modules 1 can be electrically connected in series, in parallel or in a way of series-parallel connection.

(3) The plurality of three-dimensional bases 222 (wherein, each three-dimensional base 222 supports the plurality of light emitting modules 1) are combined into the three-dimensional light source device arranged in the three-dimensional space by the two-dimensional or three-dimensional connector 225 with a quick detachable connection structure (see FIG. 23), which can emit multiple groups of multi-directional point-source light, line-source light or area-source light arranged at intervals in the three-dimensional space. Similarly, the three-dimensional bases 222 can be electrically connected in series, in parallel or in a way of series-parallel connection.

Due to the use of two-dimensional connector, in the three-dimensional light source device composed of a combination of the plurality of three-dimensional bases 222, the Z-direction axes of all three-dimensional bases 222 (that is, the Z coordinate axes when the three-dimensional bases 222 are placed horizontally in front view) are parallel to each other.

4. The two-dimensional light source base 22 assembled with one light emitting module 1 is taken as an example and described as follows.

(1) The shape and the socket

The light source base 22 is shaped like a cuboid, a cube or a cylinder, and is provided with the base socket 223 and the plurality of wire sockets 224.

The electrode plug-in extending from the LED chip 111 arranged in the light emitting module 1 is inserted and connected to the base socket 223, and the base socket 223 is connected to the light emitting module 1 by the male-female fit connection structure.

The wire socket 224 is configured to connect to other light source base 22 or the power supply module 21, and the wire socket 224 is connected to the other light source base 22 or the power supply module 21 by the circuit connector 23 or the power supply connector 211.

(2) The conduction circuit built in the light source base 22

The conduction circuit is connected between the wire socket 224 and the base socket 223. Three electrode terminals are arranged in each wire socket 224, which are the positive terminal 2241, the midline terminal 2242 and the negative terminal 2243, respectively. The positive terminals 2241 and the negative terminals 2243 of all wire sockets 224 are connected by the positive wires and the negative wires, respectively. The middle terminal 2242 of each wire socket 224 is connected to the positive or negative electrode on the base socket 223 by the wire 115. The positive and negative electrodes on the base socket 223 are respectively electrically connected to the corresponding electrode leads 119 of the LED chip 111 in the light emitting module 1 (note: one LED chip 111 can be arranged between the positive electrode and the negative electrode of the base socket 223 of the light source base 22, or the plurality of LED chips 111 connected in series can also be arranged between the positive electrode and the negative electrode of the base socket 223 of the light source base 22).

(III) Circuit connector 23

1. The usage of the circuit connector 23

As shown in FIGS. 24 and 25, the circuit connector 23 is configured to electrically connect at least two light source bases 22, that is, the circuit connector 23 is connected between the wire sockets 224 of the two adjacent light source bases 22. The power supply circuit is established between the plurality of light source bases 22 connected in series or in parallel by the circuit connector 23.

2. The structure of the circuit connector 23

The structure of the circuit connector 23 is basically the same as that of the power supply connector 211. The circuit connector 23 has several models of length, generally ranging from 12 mm to 100 mm. When the circuit connector 23 is relatively short, the circuit connector 23 is a rigid structure; and when the circuit connector 23 is relatively long, the circuit connector 23 includes the insulated outer layer 231 with bendable performance and the rigid joint 232 fixed at both ends of the circuit connector 23. The power supply wire 233 is arranged inside the rigid structure or the insulated outer layer 231 of the circuit connector 23.

The power supply wire 233 includes three long wires.

Three electrode contacts are respectively arranged on the rigid joints 232 at both ends of the circuit connector 23, which are the positive terminal, the negative terminal, and the terminal of the transition wire 2332, respectively. The three long wires are the positive wire 2331, the transition wire 2332 and the negative wire 2333, which are successively arranged side by side. Each end of the two ends of each power supply wire 233 is correspondingly fixed on the electrode terminal on the rigid joint 232.

Specifically, at least one point of the transition wire 2332 is short-circuited with the positive wire 2331 or the negative wire 2333.

When the circuit connector 23 is connected to the light source base 22 through a quick insertion-connected structure, the three electrode contacts (the positive terminal, the negative terminal and the terminal of the transition wire 2332) on the circuit connector 23 are electrically connected to the positive terminal 2241, the negative terminal 2243 and the midline terminal 2242 on the wire socket 224 arranged on the light source base 22, respectively.

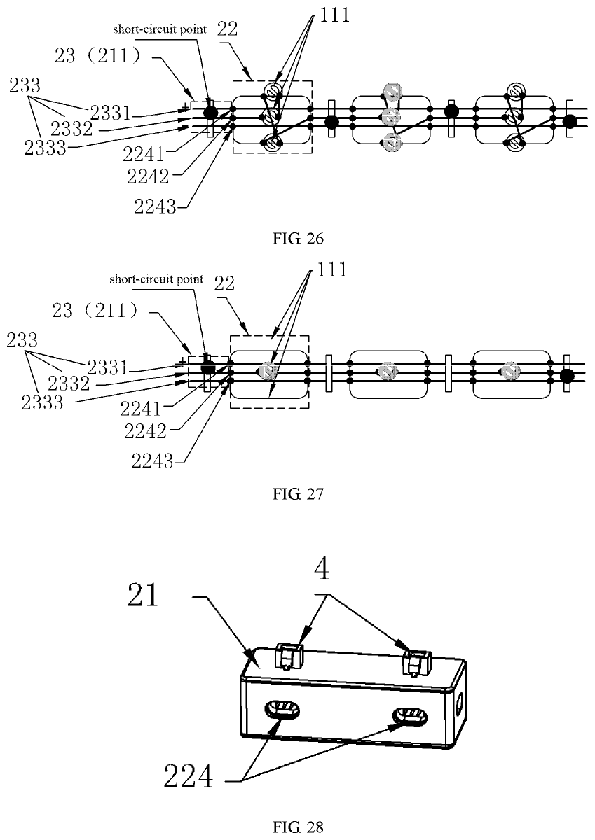

3. The use of the circuit connector 23 (see FIGS. 26 and 27).

(1) Only one point of the transition wire 2332 is short-circuited with the positive wire 2331 or the negative wire 2333.

When only one point of the transition wire 2332 is short-circuited with the positive wire 2331, the circuit connector 23 is configured as the input power supply line supplying power from one light source base 22 to another light source base 22.

When only one point of the transition wire 2332 is short-circuited with the negative wire 2333, the circuit connector 23 is configured as the output circuit line of the light source base 22 connected to the circuit connector 23.

(2) Two points of the transition wire 2332 are short-circuited with the positive wire 2331 and the negative wire 2333, respectively.

At this time, the transition wire 2332 is disconnected between the two connection points, and the circuit connector 23 is configured as both the output circuit line of one light source base 22 and the input power supply line of another light source base 22.

(3) No point of the transition wire 2332 is short-circuited with the positive wire 2331 and the negative wire 2333.

When the positive wire 2331, the transition wire 2332 and the negative wire 2333 in the circuit connector 23 are arranged in parallel without being short-circuited with each other, the circuit connector 23 is an electric power transmission line by which the two adjacent light source bases 22 are connected in series.

The light source bases 22 may be connected in series or in parallel by the circuit connector 23.

The positive wire, the negative wire, and the transition wire 2332 may be conductive copper foils, ordinary conductors 115 or RV wires.

Supporting System 3

The supporting system 3 includes several kinds of connecting blocks 31 and the rib components 32, wherein, the connecting blocks 31 can support, connect and jointly construct a special shape for the light emitting module 1 and the power supply connecting module 2, and the rib component 32 includes connecting plates, ribs, bars, rods, rigid or flexible surrounding rails, and others. By using the building block assembly connection method to connect the connecting blocks 31 and the rib components 32, the LED illumination device 9 constructed by the present invention can be combined into a light emitting device with different dimensions, different shapes and sizes to meet the customized needs of users.

Both the connecting blocks 31 and the rib components 32 are standard components.

1. Connecting block 31

The connecting block 31 may be made into standard components with different sizes, and the shape of the connecting block 31 may be a cube, a cuboid, a sphere, a truncated pyramid, a circular truncated cone. The plurality of quick insertion-connected sockets 5 (also known as quick insertion-connected ports) are arranged on the connecting block 31. Alternatively, the plurality of quick insertion-connected sockets 5 and at least one elastic snap-fit head 4 are arranged on the connecting block 31. Generally, the plurality of quick insertion-connected sockets 5 are located in different planes, respectively (of course, the plurality of quick insertion-connected sockets 5 are arranged in a same plane as needed for the connecting block 31 with a relatively large size).

When the elastic snap-fit head 4 is not arranged on the two adjacent connecting blocks 31 (see FIG. 32), the two connecting blocks 31 can be connected by the quick insertion-connected connector 312 (see FIG. 34) having at least two quick insertion-connected heads (which can be the elastic snap-fit heads 4 or other quick insertion-connected heads), that is, the quick insertion-connected heads on the quick insertion-connected connector 312 are inserted into the corresponding quick insertion-connected sockets 5, respectively. The quick insertion-connected connector 312 may be a component with a relatively short size and a rigid structure and includes at least two elastic snap-fit heads 4, or the quick insertion-connected connector 312 may be a component with a certain rigidity, bending or twisting characteristics and a relatively slightly long size and includes the elastic snap-fit head 4.

When at least one elastic snap-fit head 4 is arranged on the two adjacent connecting blocks 31, the two connecting blocks 31 can be connected by inserting the elastic snap-fit head 4 of the quick insertion-connected connector 312 into the quick insertion-connected socket 5 of the adjacent connecting block 31.

The connecting block 31 is configured to support the light source base 22 and the power supply module 21. The elastic snap-fit head 4 arranged on the light source base 22 or the power supply module 21 is inserted into the quick insertion-connected socket 5 on the corresponding connecting block 31, so that the light source base 22 and the power supply module 21 can be quickly assembled together. Moreover, the light emitting module 1, the light source base 22 and the power supply module 21 are connected and combined into the LED illumination device 9 with the desired shape and function by the quick insertion-connected connector 312.

Taking the square connecting block 31 as an example, the structure of the connecting block 31 is illustrated as follows.

As shown in FIG. 32, the quick insertion-connected socket 5 is arranged at the center of the six surfaces of the connecting block 31, and other parts of the connecting block 31 are interlaced and connected by trusses or truss plates. Each surface can be covered by the cover 311, that is, one or more unused surfaces can be covered, thus ensuring that the trusses or the truss plates on the unused surfaces on the connecting block 31 are not exposed and kept in a neat shape.

When the two such connecting blocks 31 need to be connected, the quick insertion-connected connector 312 with quick insertion-connected heads at both ends can be inserted into the quick insertion-connected sockets 5 of the two connecting blocks 31, respectively. There are two kinds of quick insertion-connected connector 312 adopted in the present embodiment.

First kind: the length of the quick insertion-connected connector 312 is not less than 12 mm, preferably 15 mm-30 mm. The quick insertion-connected connector 312 has elastic snap-fit heads 4 at both ends. The shape of the quick insertion-connected connector 312 can be linear (that is, two elastic snap-fit heads 4 are on a straight line) or curved (that is, an angle of 0-90 degrees is formed between the two elastic snap-fit heads 4).

Second kind: the length of the quick insertion-connected connector 312 is not less than 12 mm, preferably 15 mm-30 mm. The overall shape of the quick insertion-connected connector 312 is as follows: snap-fit rings with different diameters are arranged on the peripheral wall of a hollow casing (not shown in the figures), and the snap-fit rings include two large rings with a uniform diameter arranged in the middle of the hollow casing and two small rings with a uniform diameter at both ends of the hollow casing. Correspondingly, the quick insertion-connected sockets on the two connecting blocks 31 are the circular through holes that form a tight fit (transition fit or interference fit) with the two small rings and passes through the connecting block 31 (not shown in the figures). In this way, the rod-like rigid and bendable bars are configured to pass through the circular hole and the hollow casing on the connecting block 31 to connect the plurality of connecting blocks 31 in series.

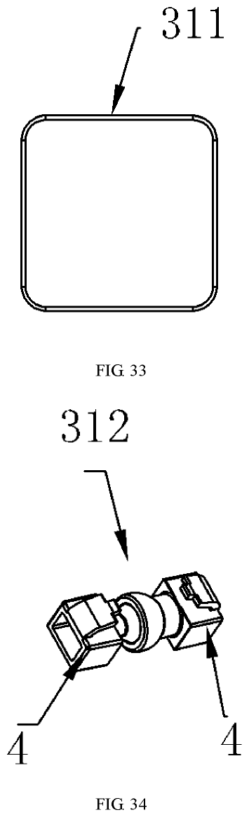

The outer surface of the cover 311 is the same as the square surface of the connecting block 31 (see FIG. 33). The inner surface of the cover 311 is provided with the elastic snap-fit head 4 which can be inserted into the quick insertion-connected socket 5 of the connecting block 31, or the elastic snap-fit head 4 which can be mounted in the circular through hole on the connecting block 31 in a snap-fit manner.

2. Rib components 32

The rib components 32 is mainly configured to fix a plurality of connecting blocks 31 or connect a plurality of connecting blocks 31 in series or in parallel. The long strip-like metal plates 321, plate connectors 322, rod connectors and pipe connectors are taken as examples to describe below.

(1) Long strip-like metal plate 321

As shown in FIG. 30, the long strip-like metal plate 321 is made of metal material, which has a certain strength and can be bent and twisted. The plurality of snap-fit holes 3211 are uniformly arranged on the long strip-like metal plate 321. The two sides (i.e. the long edge side, referred to as the snap-fit edge 3212) of the long strip-like metal plate 321 are designed to be a concave-convex alternant structure, and the concave-convex alternant structure can be a rectangular wave or a sawtooth wave in shape. The concave-convex structure of the snap-fit edge 3212 at one side of the long strip-like metal plate 321 and the concave-convex structure of the snap-fit edge 3212 at the other side of the long strip-like metal plate 321 are staggered relative to each other in the direction of the long edge side of the long strip-like metal plate 321, that is, when the two long strip-like metal plates 321 with the same size and shape are juxtaposed and connected in a complementary manner (that is, the two snap-fit edges 3212 arranged by the concave-convex structure on the two long strip-like metal plates 321 are connected), the joint portion of the two long strip-like metal plates 321 is seamless.

The long strip-like metal plate 321 can be placed in the form of a flat plate, or the long edge of the long strip-like metal plate 321 can be rolled into a ring around an axis parallel to the short edge, or the two short edges of the long strip-like metal plate 321 can be twisted into a twist shape along opposite directions.

The connecting block 31 is fixed on the plate surface of the long strip-like metal plate 321 by inserting the elastic snap-fit head 4 into the snap-fit hole 3211; or, the connecting block 31 is fixed on the long strip-like metal plate 321 by the quick insertion-connected connector 312 with two quick insertion-connected heads (that is, one quick insertion-connected head of the quick insertion-connected connector 312 is inserted into the quick insertion-connected socket 5 of the connecting block 31, and the other quick insertion-connected head of the quick insertion-connected connector 312 is inserted into the snap-fit hole 3211 on the long strip-like metal plate 321).

(2) Plate connector 322

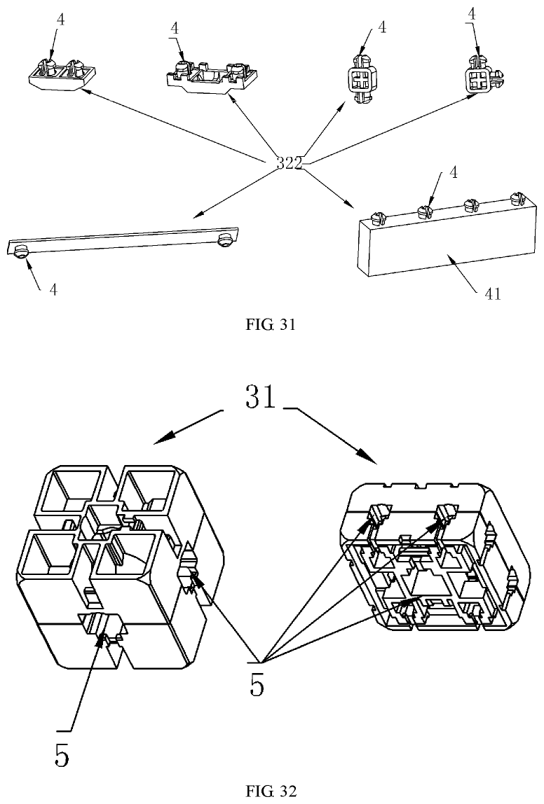

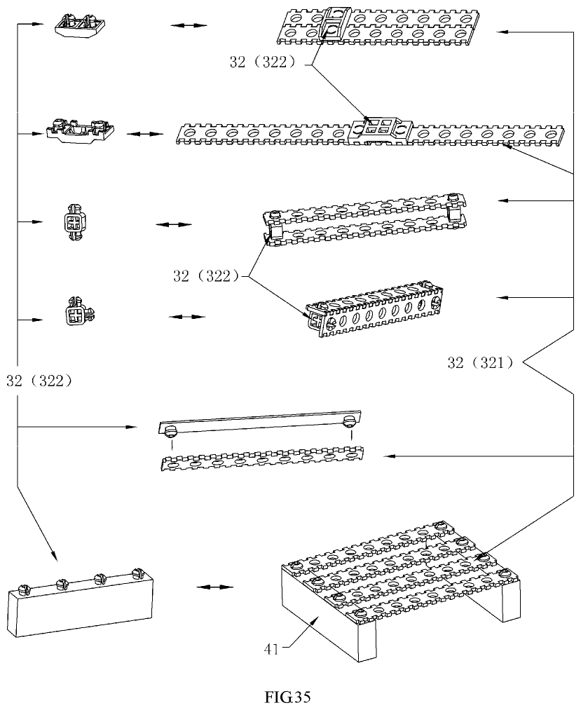

As shown in FIGS. 31 and 35, the plate connector 322 is configured to connect two long strip-like metal plates 321 in different forms.

The plate connector 322 is made of rigid plastic and is provided with at least two elastic snap-fit heads 4. The two elastic snap-fit heads 4 can be inserted into one of the snap-fit holes 3211 on different long strip-like metal plates 321 respectively to fix the numerically equally long strip-like metal plates 321.

a. Plate connector 322 with two elastic snap-fit heads 4

The two elastic snap-fit heads 4 can be arranged on the same side, on the adjacent sides, or on the opposite sides.

When the two elastic snap-fit heads 4 are arranged on the same side, the distance between the two elastic snap-fit heads 4 has the following four settings.

Firstly, the distance between the two elastic snap-fit heads 4 is greater than the distance between the two adjacent snap-fit holes 3211 on the two long strip-like metal plates 321 when the two long strip-like metal plates 321 are laterally connected (that is, the long edges of the long strip-like metal plates 321 are connected). In this connection mode, a certain distance is left between the snap-fit edges 3212 corresponding to the two long strip-like metal plates 321 in preparation for the installation of other decorative parts.

Secondly, the distance between the two elastic snap-fit heads 4 is equal to the distance between the two adjacent snap-fit holes 3211 on the two long strip-like metal plates 321 when the two long strip-like metal plates 321 are laterally connected. In this connection mode, the snap-fit edges 3212 corresponding to the two long strip-like metal plates 321 are seamlessly connected.

Thirdly, the distance between the two elastic snap-fit heads 4 is equal to the distance between the two adjacent snap-fit holes 3211 on the two long strip-like metal plates 321 when the two long strip-like metal plates 321 are longitudinally connected (that is, the short edges of the long strip-like metal plates 321 are connected). In this connection mode, the two long strip-like metal plates 321 can extend along the direction of the long edge.

Fourthly, the distance between the two elastic snap-fit heads 4 is equal to the length of the long strip-like metal plate 321, that is, one elastic snap-fit head 4 is inserted into the snap-fit hole 3211 at one end of the long strip-like metal plate 321 (along the direction of the long edge of the long strip-like metal plate 321), and the other elastic snap-fit head 4 is inserted into the snap-fit hole 3211 at the other end of the long strip-like metal plate 321. In this connection mode, the strength of the long strip-like metal plate 321 is improved.

When the two elastic snap-fit heads 4 are arranged on the adjacent sides, the angle formed between the two elastic snap-fit heads 4 can be changed from 0 degrees to 90 degrees.

This setting enables the desired angle to be formed between the plate surfaces of the long strip-like metal plate 321 connected to each other.

When the two elastic snap-fit heads 4 are arranged on the opposite sides, the two long strip-like metal plates 321 connected to each other can be in a parallel state.

b. Plate connector 322 with the plurality of elastic snap-fit heads 4

The plurality of elastic snap-fit heads 4 are arranged on the same side, and all the elastic snap-fit heads 4 are fixedly attached to one side of the cuboid bracket 41 with a certain strength and a set height, wherein each elastic snap-fit head 4 is mounted in the snap-fit hole 3211 at one end of different long strip-like metal plates 321 in a snap-fit manner. Two connectors with a plurality of elastic snap-fit heads 4 are respectively connected to the two ends of the plurality of long strip-like metal plates 321, so that the plurality of long strip-like metal plates 321 can be parallelly fixed to the cuboid bracket 41.

The distance between each two adjacent elastic snap-fit heads 4 in the plurality of elastic snap-fit heads 4 is determined according to the need, which can be uniform or of different sizes, wherein, when the two adjacent long metal plates 321 are seamlessly connected by the snap-fit edges 3212, the minimum distance between two adjacent elastic snap-fit heads is not less than the distance between the two adjacent snap-fit holes 3211 on the two long strip-like metal plates 321.

(3) Rod connector (not shown in the figures)

The plurality of connecting blocks 31 or long strip-like metal plates 321 are connected to form the desired shape by using the standard components with a certain stiffness such as a straight rod or a bending rod. The connection mode may be an insertion connection, a screwed connection, a snap-fit connection or a male-female fit connection.

(4) Pipe connector (not shown in the figures)

The pipe connector is basically the same as the rod connector described above, except that the pipe connector is a hollow tube. A relatively long straight rod or a curved rod is inserted through the pipe connector, and the relatively long straight rod or the curved rod are configured to connect the decorative parts of other standard components.

IV. Light transmission cover 8

The light transmission cover 8 can be a standard component. The light transmission cover 8 can be arranged on the light emitting module 1 by a quick detachable structure as needed, and the light transmission cover 8 can be a simple-shaped lampshade, or a decorative lampshade composed of curved surfaces with different curvatures, wherein, the decorative lampshade can refract and reflect a light emitted from the light emitting module 1 and then emit the light from a set orientation.

What is claimed is:

1. A basic framework for constructing an LED illumination device using standard components, comprising at least one light emitting module, a at least one power supply connecting module, and a supporting system configured to support and decorate the LED illumination device, wherein:
each light emitting module of the at least one light emitting module comprises an LED light source integrated with a chip and a heat sink, a color temperature adjusting module and a light lens; each of the color temperature adjusting module and the light lens is fixed on the LED light source by a quick detachable structure;
each power supply connecting module of the at least one power supply connecting module comprises a power supply module with a plurality of different voltage output sockets, a light source base, a power supply connector electrically connecting the light source base and the power supply module, and a circuit connector electrically connecting two adjacent light source bases; wherein, the at least one light emitting module is assembled on the light source base, a conduction circuit is built into the light source base, and each power supply connecting module is provided with the light source base;
the supporting system comprises a plurality of connecting blocks with a building block-type connecting structure, and a rib component; the rib component comprises a connecting plate, a rib, a bar, a rod and a surrounding rail, and the rib is configured to combine the plurality of connecting blocks into brackets with different dimensions, different shapes and different sizes by a building block assembly connection method; the plurality of connecting blocks and the light source base are provided with a quick insertion-connected connector, the quick insertion-connected connector has a rigid structure and the quick insertion-connected connector is configured to quickly assemble the plurality of connecting blocks and the light source base; and
each of the LED light source, the color temperature adjusting module, the light lens, the power supply module, the light source base, the power supply connector, the circuit connector, the connecting block and the rib component is a standard component.

2. The basic framework for constructing the LED illumination device using the standard components according to claim 1, wherein, a base socket and a plurality of wire sockets adaptively connected to the circuit connector are arranged on the light source base; the conduction circuit in the light source base is connected between the plurality of wire sockets and the base socket; three electrode terminals are arranged in each wire socket of the plurality of wire sockets and the three electrode terminals are a positive terminal, a midline terminal and a negative terminal, respectively; the positive terminals of the plurality of wire sockets are connected to each other by a positive wire, and the negative terminals of all the plurality of wire sockets are connected to each other by a negative wire; the midline terminal of each wire socket is connected to a positive electrode or a negative electrode of the base socket through a wire.

3. The basic framework for constructing the LED illumination device using the standard components according to claim 2, wherein, the LED light source comprises an LED chip and the heat sink configured to support the LED chip; a spatial shape surrounded by an outline of the heat sink is a truncated pyramid, a circular truncated cone, a prism or a cylinder; the heat sink is a heat conductor, or the heat sink is a support component and an outer surface of the support component is coated with a thermally conductive film; the LED chip is arranged in face-to-face contact with a top surface of the heat sink; a positive lead and a negative lead of the LED chip are insulated from the heat sink and extend out to form a standard plug-in, and the standard plug-in is inserted on the base socket.

4. The basic framework for constructing the LED illumination device using the standard components according to claim 2, wherein, the circuit connector comprises an insulated outer layer with bendable performance, a rigid joint fixed at both ends of the circuit connector, and a power supply wire built in the insulated outer layer; the power supply wire comprises three wires, the three wires are the positive wire, a transition wire and the negative wire, respectively, and the three wires are successively arranged side by side; each end of two ends of the power supply wire is correspondingly fixed on an electrode terminal on the rigid joint, wherein the electrode terminal on the rigid joint corresponds to the each end of two ends of the power supply wire; the positive wire is short-circuited with the transition wire to form an input power supply line of the light source base; the negative wire is short-circuited with the transition wire to form an output circuit line of the light source base; the positive wire, the transition wire and the negative wire in the circuit connector are arranged in parallel to form an electric energy transmission line, and at least two light emitting modules are connected in series by the electric energy transmission line.

5. The basic framework for constructing the LED illumination device using the standard components according to claim 4, wherein, the rigid joint is connected to the wire socket on the light source base by a male-female fit connection structure, and the positive wire is electrically connected to the positive terminal, the transition wire is electrically connected to the midline terminal, and the negative wire is electrically connected to the negative terminal.

6. The basic framework for constructing the LED illumination device using the standard components according to claim 4, wherein, three LED chips connected in series are arranged between the positive electrode and the negative electrode of the base socket.

7. The basic framework for constructing the LED illumination device using the standard components according to claim 2, wherein, each connecting block of the plurality of connecting blocks is a cube, a cuboid, a sphere, a truncated pyramid or a circular truncated cone, and the each connecting block is provided with a plurality of quick insertion-connected sockets arranged in different planes and at least one elastic snap-fit head; the quick insertion-connected connector is arranged between the plurality of quick insertion-connected sockets of the two adjacent connecting blocks of the plurality of connecting blocks.

8. The basic framework for constructing the LED illumination device using the standard components according to claim 7, wherein, the rib component comprises a long strip-like metal plate having a certain strength to play a supporting role, and the long strip-like metal plate is bendable and twistable; a plurality of snap-fit holes are arranged at intervals from a first end of the long strip-like metal plate to a second end of the long strip-like metal plate; a snap-fit edge at each side of a first side and a second side of the long strip-like metal plate are provided with a concave-convex structure at intervals; the concave-convex structure of the snap-fit edge at the first side of the long strip-like metal plate and the concave-convex structure of the snap-fit edge at the second side of the long strip-like metal plate are alternate relative to each other in a direction of a long edge side of the long strip-like metal plate 321; the connecting block is fixed on a plate surface of the long strip-like metal plate by inserting the at least one elastic snap-fit head into the plurality of snap-fit holes.

9. The basic framework for constructing the LED illumination device using the standard components according to claim 8, wherein, the rib component further comprises a plate connector with at least two elastic snap-fit heads, and the at least two elastic snap-fit heads are inserted into the plurality of snap-fit holes on different long strip-like metal plates respectively to fix and connect the different long strip-like metal plates corresponding to the at least two elastic snap-fit heads.

10. The basic framework for constructing the LED illumination device using the standard components according to claim 9, wherein, when two elastic snap-fit heads are provided on the plate connector, the two elastic snap-fit heads are arranged on a same side, on adjacent sides, or on opposite sides.

11. The basic framework for constructing the LED illumination device using the standard components according to claim 10, wherein, a distance between the two elastic snap-fit heads arranged on the same side of the plate connector is greater than a distance between two adjacent snap-fit holes on two long strip-like metal plates when the two long strip-like metal plates 321 are laterally connected; alternatively, the distance between the two elastic snap-fit heads arranged on the same side is equal to the distance between two adjacent snap-fit holes on the two long strip-like metal plates when the two long strip-like metal plates 321 are longitudinally connected.

12. The basic framework for constructing the LED illumination device using the standard components according to claim 9, wherein, the at least two elastic snap-fit heads are provided on the plate connector, and the at least two elastic snap-fit heads are arranged on a same side; the at least two elastic snap-fit heads are fixed on a side of the cuboid; when two long strip-like metal plates of the different long strip-like metal plates are laterally coupled, a distance between two adjacent elastic snap-fit heads of the at least two elastic snap-fit head is not less than a distance between two adjacent snap-fit holes of the plurality of snap-fit holes on the two long strip-like metal plates.

13. The basic framework for constructing the LED illumination device using the standard components according to claim 11 or 12, wherein, the rib component further comprises at least one rod connector or pipe connector, and the each connecting block is correspondingly provided with a spiral hole, a snap-fit hole or a through hole, wherein the rod connector or the pipe connector is fixed to the spiral hole, the snap-fit hole or the through hole.

14. The basic framework for constructing the LED illumination device using the standard components according to claim 7, wherein, a surface of the each connecting block provided with the plurality of quick insertion-connected sockets is provided with a cover, and the cover is configured to cover the plurality of quick insertion-connected sockets; a surface shape of the cover is the same as a surface shape of the each connecting block provided with the plurality of quick insertion-connected sockets.

15. The basic framework for constructing the LED illumination device using the standard components according to claim 2, wherein, a housing of the power supply module is provided with a plurality of power output sockets, at least one utility-frequency power connection socket and at least one elastic snap-fit head, and direct current output voltages of the power output sockets range from 12V to 48V.

16. The basic framework for constructing the LED illumination device using the standard components according to claim 15, wherein, the power supply module is further provided with a digital signal transmission line and an IC chip configured to control different light emitting modules.

17. The basic framework for constructing the LED illumination device using the standard components according to claim 16, wherein, the power supply module is further provided with at least one wire socket, and the circuit connector connects at least two power supply modules for use.

18. The basic framework for constructing the LED illumination device using the standard components according to claim 1, wherein, the power supply connector comprises an insulated outer layer with bendable performance, a rigid joint fixed at both ends of the power supply connector, and a power supply wire built in the insulated outer layer; the power supply wire comprises three wires, the three wires are a positive wire, a transition wire and a negative wire, respectively, and the three wires are successively arranged side by side; each end of two ends of each power supply wire is fixed on an electrode terminal on the rigid joint corresponding to the each end of two ends of the power supply wire; when the positive wire is short-circuited with the transition wire to form an input power supply line of the light source base, the light source base is connected to the power supply module by the input power supply line; when the negative wire is short-circuited with the transition wire to form an output circuit line of the light source base, the light source base is connected to the power supply connector by the output circuit line; when the positive wire, the transition wire and the negative wire in the power supply connector are arranged in parallel to form a parallel connection line, a plurality of light emitting modules are connected in series by the parallel connection line.

19. The basic framework for constructing the LED illumination device using the standard components according to claim 1, wherein, the LED illumination device is an illumination light or a large indicator light, comprising a table lamp, a wall lamp, a hanging light, a chandelier, a suctorial ceiling light, a globular light, a decorative light, a street light, a tunnel light, and a car light; alternatively, the LED illumination device is a phototherapy instrument for light physiotherapy.

20. The basic framework for constructing the LED illumination device using the standard components according to claim 19, wherein, a light transmission cover is arranged on the LED illumination device.
